(19) United States
(12) Patent Application Publication
(10) Pub. No.: US 2024/0113470 A1
(43) Pub. Date: Apr. 4, 2024

(54) Family Seal Performance and Waterproof Connector

(71) Applicant: Tyco Electronics Japan G.K., Kawasaki-shi (JP)

(72) Inventor: Ryuichi Komiyama, Shizuoka (JP)

(73) Assignee: Tyco Electronics Japan G.K., Kawasaki-shi (JP)

(21) Appl. No.: 18/477,751

(22) Filed: Sep. 29, 2023

(30) Foreign Application Priority Data
Sep. 30, 2022 (JP) 2022-158559

(51) Int. Cl. H01R 13/52

(52) U.S. Cl. CPC H01R 13/521

(57) ABSTRACT

A waterproofing element comprises a seal element and a supporting element. The seal element includes a plurality of first waterproofing portions each defining a plug hole adapted to receive and form a seal with a conductive contact, and a second waterproofing portion adapted to sealingly contact an inner wall surface of a housing. The supporting element surrounds the first waterproofing portions and is adapted to prevent misalignment of the first waterproofing portions. The second waterproofing portion arranged over the supporting element such that the supporting element presses the second waterproofing portion in a radially outward direction for forming a seal therewith.

### CROSS-REFERENCE TO RELATED APPLICATION

This application claims the benefit of Japanese Patent Application No. 2022-158559 filed on Sep. 30, 2022, the whole disclosure of which is incorporated herein by reference.

### FIELD OF THE INVENTION

The present invention relates to a waterproof connector including a plurality of contacts and to a waterproofing element that is used in the waterproof connector.

### BACKGROUND

Waterproof connectors having a plurality of contacts typically include a seal arranged within a housing of the connector and through which the contacts pass. Accordingly, this seal must be adapted to prevent water from entering through first entry paths defined along each of those contacts, as well as through a second entry path along an inner wall surface of the housing.

A seal element according to the prior art, commonly called a family seal, inhibits entry of water through both of these first and second entry paths with one seal element. This family seal includes multiple first waterproofing portions each having a plug hole into which one contact is plugged, and a second waterproofing portion that comes into contact with an inner wall surface of a housing to prevent water from entering a space between the inner wall surface and the seal element.

Family seals are typically made of a highly elastic material such as a rubber material. This poses a problem of excess deformation or a misalignment in a direction intersecting a direction in which a contact is plugged. More specifically, the presence of deformation or misalignment in any of the first waterproofing portions makes it difficult to plug the contact. Alternatively, if it is even possible to plug the contact, prevent the formation of a reliable seal. Further, the presence of a misalignment in the second waterproofing portion may make it impossible to completely prevent water from entering the second entry path along the inner wall surface. For this reason, at the time of assembly, it is necessary to handle the family seal with care, for example, by positioning each portion of the family seal with high precision so that no deformation or no misalignment occurs.

Given these drawbacks, a waterproofing element that fulfills a function as a family seal and that is easily handled at the time of assembly and a waterproof connector including the waterproofing element is desired.

### SUMMARY

According to an embodiment of the present disclosure, a waterproofing element comprises a seal element and a supporting element. The seal element includes a plurality of first waterproofing portions each defining a plug hole adapted to receive and form a seal with a conductive contact, and a second waterproofing portion adapted to sealingly contact or engage with an inner wall surface of a housing. The supporting element surrounds the first waterproofing portions and is adapted to prevent misalignment of the first waterproofing portions. The second waterproofing portion is arranged over the supporting element such that the supporting element presses the second waterproofing portion in a radially outward direction for forming a seal therewith.

### BRIEF DESCRIPTION OF THE DRAWINGS

The invention will now be described by way of example with reference to the accompanying Figures, of which:

FIG. 1 is an isometric view of a waterproof connector of a first embodiment of the present invention.

FIG. 2 is an exploded isometric view of the waterproof connector shown in FIG. 1.

FIG. 3 is a hexahedral view of the waterproof connector.

FIG. 4 is a cross sectional view taken along arrow A-A shown in (C) of FIG. 3.

FIG. 5 is a cross sectional view taken along arrow B-B shown in (C) of FIG. 3.

FIG. 6 is a cross sectional view taken along arrow C-C shown in (D) of FIG. 3.

FIG. 7 is an enlarged isometric view of a waterproofing element as seen obliquely from behind.

FIG. 8 is an enlarged cross sectional view of the waterproofing element in the cross sectional view of FIG. 4.

FIG. 9 is an enlarged cross sectional view of the waterproofing element in the cross sectional view of FIG. 5. FIG. 10 is an enlarged cross sectional view of the waterproofing element in the cross sectional view of FIG. 6.

FIG. 11 is an isometric view of a waterproofing element that constitutes a waterproof connector of a second embodiment.

FIG. 12 is a cross sectional view showing the waterproof connector of the second embodiment and corresponding to FIG. 4 of the first embodiment.

FIG. 13 is a cross sectional view showing the waterproof connector of the second embodiment and corresponding to FIG. 5 of the first embodiment.

FIG. 14 is a cross sectional view showing the waterproofing element that constitutes the waterproof connector of the second embodiment and corresponding to FIG. 8 of the first embodiment.

FIG. 15 is a cross sectional view showing the waterproofing element that constitutes the waterproof connector of the second embodiment and corresponding to FIG. 9 of the first embodiment.

FIG. 16 is an isometric view of a waterproofing element that constitutes a waterproof connector of a third embodiment.

FIG. 17 is a cross sectional view showing the waterproof connector of the third embodiment and corresponding to FIG. 4 of the first embodiment.

FIG. 18 is a cross sectional view showing the waterproof connector of the third embodiment and corresponding to FIG. 5 of the first embodiment.

FIG. 19 is a cross sectional view showing the waterproofing element that constitutes the waterproof connector of the third embodiment and corresponding to FIG. 8 of the first embodiment.

FIG. 20 is a cross sectional view showing the waterproofing element that constitutes the waterproof connector of the third embodiment and corresponding to FIG. 9 of the first embodiment.

FIG. 21 is an isometric view of a waterproof connector of a fourth embodiment.

FIG. 22 is an isometric view of a waterproofing element that constitutes the waterproof connector of the fourth embodiment.

FIG. 23 is a cross sectional view showing the waterproofing element that constitutes the waterproof connector of the fourth embodiment and corresponding to FIG. 10 in the first embodiment.

FIG. 24 is an isometric view of a waterproof connector of a fifth embodiment.

FIG. 25 is an isometric view of a waterproofing element that constitutes the waterproof connector of the fifth embodiment.

FIG. 26 is a cross sectional view showing the waterproofing element that constitutes the waterproof connector of the fifth embodiment and corresponding to FIG. 10 in the first embodiment.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

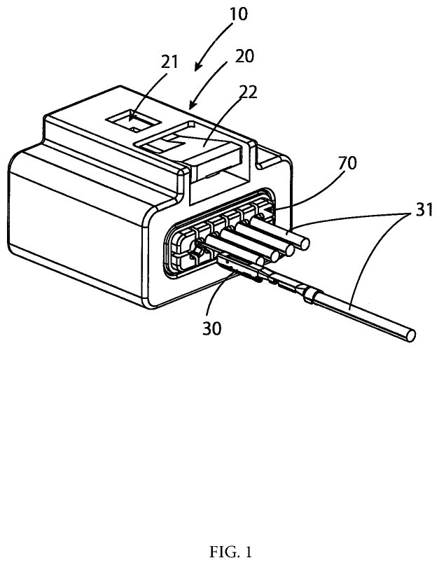

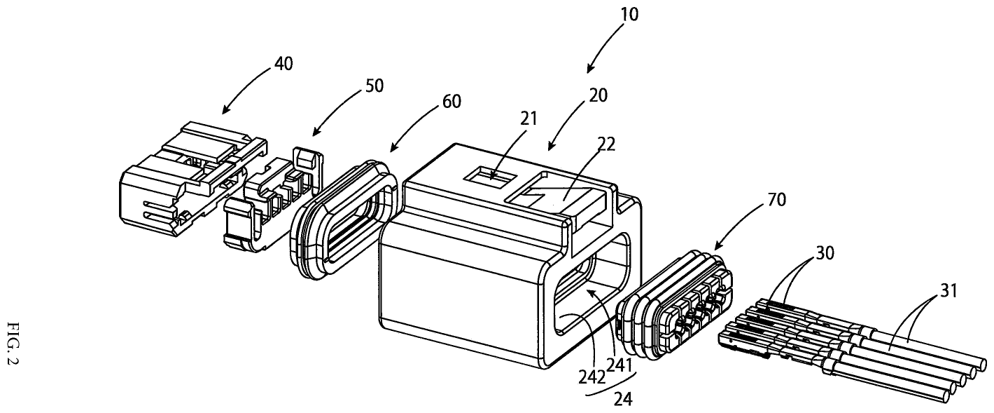

FIG. 1 is an isometric view of a waterproof connector of a first embodiment of the present invention. FIG. 2 is an exploded isometric view of the waterproof connector shown in FIG. 1. The waterproof connector 10 includes a plug housing 20 and five female contacts 30. FIG. 1 shows the shape of the five contacts 30 before being plugged into the plug housing 20. An electric wire 31 is connected to each contact. Only a front end of the electric wire 31 is shown, although the electric wire 31 extends longer. The plug housing 20 is equivalent to an example of what is called “housing” in the present disclosure, and the contacts 30 are equivalent to an example of what are called “contacts” in the present disclosure. The waterproof connector 10 includes a front cavity 40, a retainer 50, a seal ring 60, and a waterproofing element or assembly 70 in addition to the plug housing 20 and the five contacts 30. The waterproofing element 70 is equivalent to a first embodiment of what is called “waterproofing element” in the present invention.

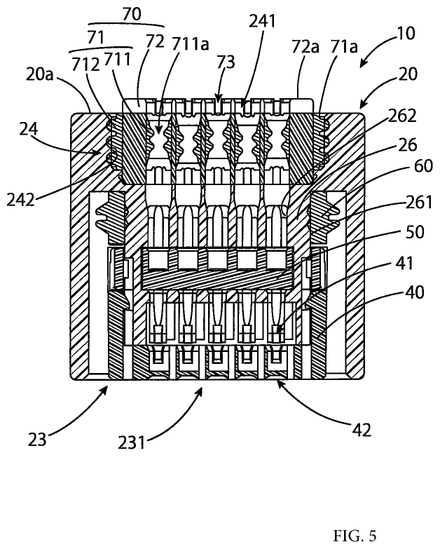

The plug housing 20 has formed in an upper surface thereof an upper surface opening 21 that is open upward and a lock arm 22 extending in such a manner as to get into under the upper surface opening 21. The lock arm 22 has formed therein a lock hole 221 into which an engaging portion 91 of a mating connector 90 (see FIG. 5) that is mated with the waterproof connector 10 is fitted. The fitting of the engaging portion 91 into the lock hole 221 causes the waterproof connector 10 and the mating connector 90 to be locked into a mated state.

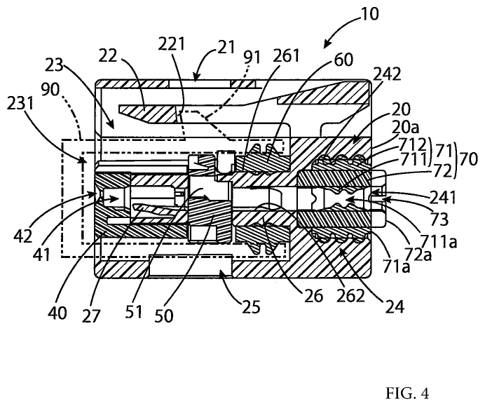

The plug housing 20 may be a resin molded article. The upper surface opening 21 of the plug housing 20 is an opening needed to form the lock hole 221 of the lock arm 22 at the time of molding. Further, the plug housing 20 has on a front side thereof, i.e., a side thereof that is mated with the mating connector 90, a mating portion 23 (see, for example, FIG. 4) that is mated with the mating connector 90. The mating portion 23 has formed therein a front surface opening 231 that is open forward. Through the front surface opening 231, the seal ring 60 and the front cavity 40 are inserted and, furthermore, the mating connector 90 is plugged at the time of mating. The front surface opening 231 is equivalent to an example of what is called “first opening” in the present invention.

The plug housing 20 further includes with a waterproofed portion 24 having a back surface opening 241 bored through a back surface 20a of the plug housing 20 and a surrounding inner wall surface 242. Through the back surface opening 241, the waterproofing element 70 is inserted, and into the waterproofing element, the contacts 30 are plugged. The back surface opening 241 is equivalent to an example of what is called “second opening” in the present invention. The plug housing 20 also has a bottom surface thereof a bottom surface opening 25 (see FIG. 4) that is open downward. Through the bottom surface opening 25, the retainer 50 is plugged.

In assembling the waterproof connector 10, the seal ring 60 is fitted onto the plug housing 20 first. Next, the retainer 50 is plugged into a temporary catch position and the front cavity 40 is fitted. The waterproofing element 70 is then fitted, and the contacts 30 are plugged therethrough. Finally, the retainer 50 is plugged into a complete catch position.

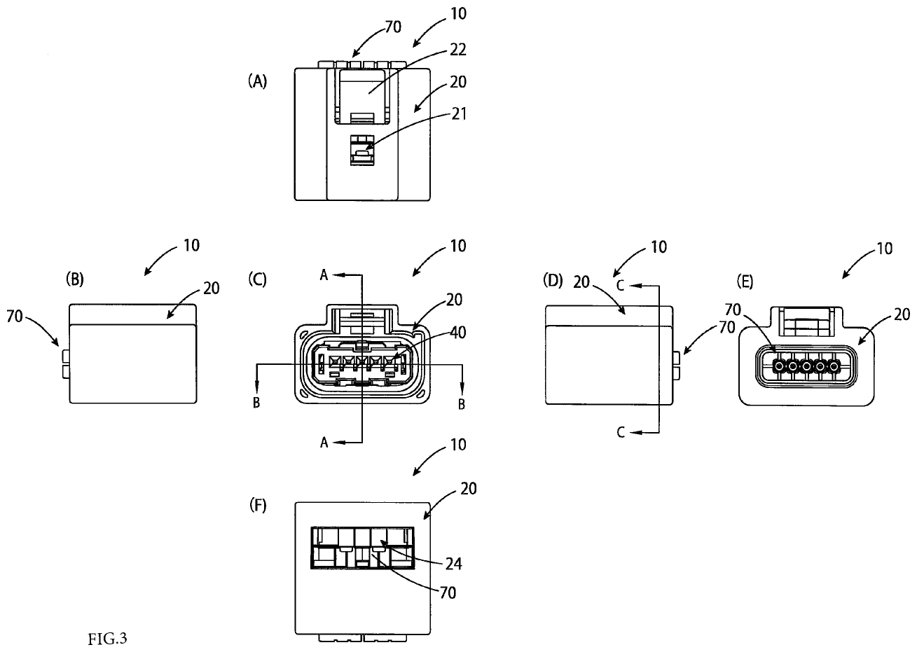

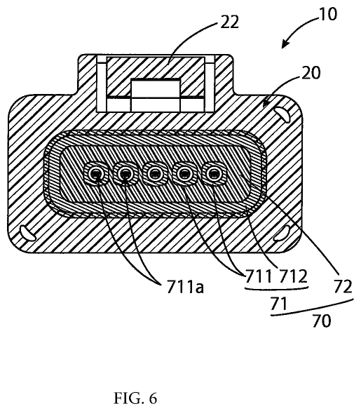

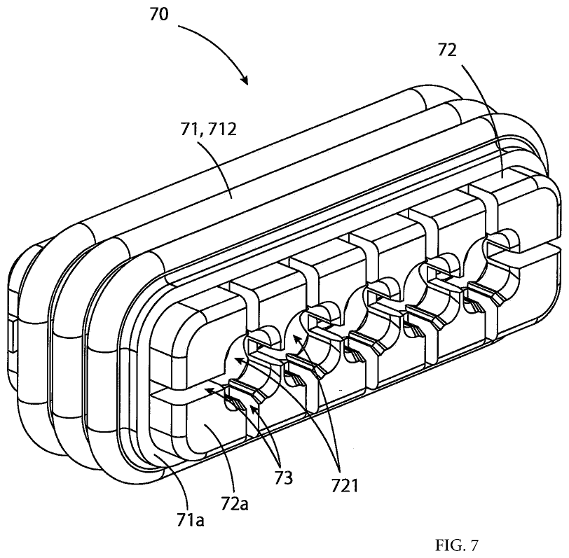

FIG. 3 is a hexahedral view of the waterproof connector. That is, views (A) to (F) of FIG. 3 are a top view (A), a left side view (B), a front view (C), a right side view (D), a back view (E), and a bottom view (F). Note, however, that FIG. 3 and subsequent drawings omit to illustrate the contacts. FIG. 3 indicate cross-sectional positions of the cross sectional views illustrated below. FIG. 4 is a cross sectional view taken along arrow A-A shown in (C) of FIG. 3. Further, FIG. 5 is a cross sectional view taken along arrow B-B shown in (C) of FIG. 3. Furthermore, FIG. 6 is a cross sectional view taken along arrow C-C shown in (D) of FIG. 3. The cross sectional views of FIGS. 4-6 are enlargements of the drawings shown in FIG. 3.

As illustrated, the seal ring 60 is fitted in the plug housing 20 in such a manner as to surround an outer wall 261 of a tubular portion 26 of the plug housing. The seal ring 60 is in contact with an inner wall surface 92 of the mating connector 90 thus mated and serves to prevent water from entering the inside of the mating connector.

The retainer 50 is fitted in the complete catch position in FIGS. 4 and 5. The temporary catch position of the retainer 50 is a position in which the retainer is slightly lower in FIG. 4 than it is in the complete catch position. When the retainer 50 is in the temporary catch position, a contact passage portion 51 of the retainer communicates with a contact passage portion 262, which is bored back and forth, of the tubular portion 26 of the plug housing 20, so that the contacts 30 can be plugged.

Further, the front cavity 40 is provided with a recess or hollow 41 into which the tip of a contact is plugged and a pin plugging opening 42 that is open forward and that is connected to the hollow. Through the pin plugging opening 42, a male contact (not illustrated) of the mating connector 90 is plugged to make contact with a contact 30 (see FIG. 2) of the waterproof contact 10 for electrical continuity.

The waterproofing element 70 is inserted into the waterproofed portion 24 through the back surface opening 241 of the plug housing 20. The waterproofing element 70 comprises a seal element 71 and a supporting element 72. The supporting element 72 has through holes 721 formed therein. Further, the seal element 71 has a first waterproofing portion 711 placed inside the through hole 721 and a second waterproofing portion 712 disposed to surround the outer periphery of the supporting element 72. The first waterproofing portion 711 has a plug hole 711a.

When the retainer 50 is in the temporary catch position, a contact 30 (see FIG. 2) is plugged through the plug hole 711a of the waterproofing element 70 so that the tip of the contact 20 is in a normal position in the hollow 41 of the front cavity 40. Then, the contact 30 is temporarily caught by a lance 27 provided in the plug housing 20. After that, when the retainer 50 is plugged into a full catch position shown in FIG. 4, the contact 30 is fully caught to be retained.

FIG. 7 is an enlarged isometric view of a waterproofing element as seen obliquely from behind. As shown, the waterproofing element 70 is the first embodiment of the waterproofing element of the present invention. The seal element 71 is made of a highly elastic rubber material. The supporting element 72 is made of a resin material, supports the seal element 71, and serves to inhibit the seal element from getting out of shape. The supporting element 72 has formed therein five through holes 721 bored in a front-back direction. The supporting element 72 protrudes further backward than the seal element 71, and the backward protruding portion of the supporting element has formed therein a drain groove 73 leading to a through hole 721 and extending to an end of the supporting element 70 in directions (in the example shown here, an up-down direction and a right-left direction) intersecting the front-back direction.

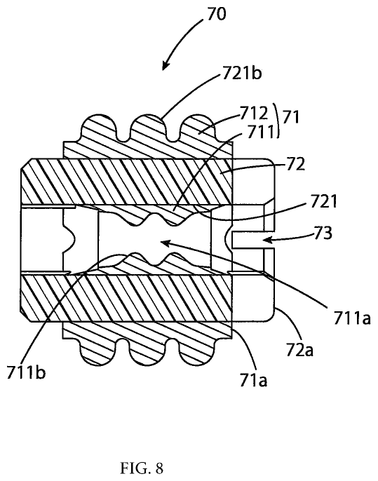

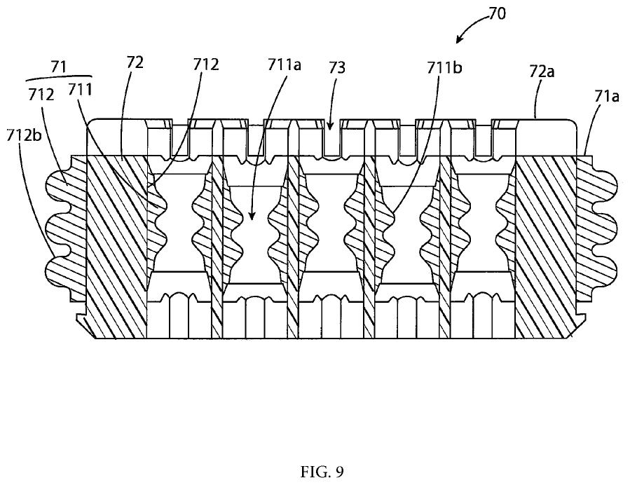

FIGS. 8, 9 and 10 are enlarged cross sectional views of the waterproofing element in the cross sectional views of FIGS. 4, 5, and 6, respectively. As shown, the seal element 71 is a family seal type seal element and has a first waterproofing portion or element 711 placed inside a through hole 721 of the supporting element 72 and a second preventing portion or element 712 surrounding the outer periphery of the supporting element. The supporting element 72 has five of these through holes 721 formed therein, and a total of five of these first waterproofing portions 711 are provided separately inside each of those five through holes.

The waterproofing element 70 is a molded article obtained by integrating the seal element 71 and the supporting element 72, and the seal element and the supporting element are in watertight close contact with each other. That is, the first waterproofing portion 711 is in close contact with an inner wall surface 721a of the through hole 721 of the supporting element 72 to prevent water from entering along the inner wall surface. Further, the second waterproofing portion 712 is in close contact with an outer wall surface 72b of the supporting element 72 to prevent water from entering along the outer wall surface.

Further, the first waterproofing portion 711 has a plug hole 711a into which a contact 30 is plugged, and the first waterproofing portion has an inner wall surface 711b in which the plug hole is formed. The inner wall surface 711b is formed in a waterproof shape repeatedly corrugated in the front-back direction. When the contact 30 is plugged into the plug hole 711a, the inner wall surface 711b comes into contact with the contact while being crushed, with the result that a path of entry of water along the contact is blocked off.

With the contact 30 plugged into the plug hole 711, the path of entry of water along the contact is blocked off, but water tends to accumulate in a part immediately behind the blockage. The drain groove 73 formed in the portion of the supporting element 72 protruding further backward than the seal element 71 serves to let out water that otherwise tends to accumulate in the part immediately behind the blockage and inhibit the formation of a puddle there.

Further, in the case of the waterproofing element 70 of the first embodiment, the supporting element 72 protrudes further backward than the seal element 71. For this reason, even if a bending force is applied to the electric wire 31 (see FIGS. 1 and 2), the force is hardly transmitted to the first waterproofing portion 711. Therefore, the waterproof performance of the first waterproofing portion 711 can be kept highly reliable.

The second waterproofing portion 712 too has its outer wall surface 712b formed in a waterproof shape repeatedly corrugated in the front-back direction. When the waterproofing element 70 is inserted into the waterproofed portion 24 through the back surface opening 241 of the plug housing 20, the outer wall surface 712b of the second waterproofing portion 712 of the seal element 71 comes into all-around contact with the inner wall surface 242 of the waterproofed portion 24 while being crushed. As a result, a path of entry of water along the inner wall surface 242 is blocked off.

In each of FIGS. 4-6, the second waterproofing portion 712 appears to be penetrating into the inner wall surface 242 of the waterproofed portion 24 of the plug housing 20. This is because the shape of the second waterproofing portion 712 in the absence of an external force acting thereon is shown as-is. In actuality, the projections of the corrugated shape are crushed under reaction force from the inner wall surface 242 of the waterproofed portion 24, with the result that a watertight state is brought about. Thus, the waterproof connector 10 is obtained by integrally molding the family seal type seal element 71 and the supporting element 72, and the supporting element reducing undesired deformation of the seal element. Accordingly, handling at the time of assembly is easier than in the case of a family seal type seal element that is not integrated with a supporting element.

The foregoing has stated that the seal element 71 and the supporting element 72, which constitute the waterproofing element 70, are integrally molded. Although integral molding is a preferred manufacturing method, the seal element 71 and the supporting element 72 are not necessarily need to be integrally molded. The seal element and the supporting element may be fabricated separately, and for example, adhesion or other processes may be used or expansion and contraction of the seal element may be utilized to achieve a structure in which the seal element 71 and the supporting element 72 are in watertight contact with each other.

Next, a waterproof connector of a second embodiment is described. In the following description of the second embodiment and a description of a third embodiment that follows, elements that correspond to those of the first embodiment are given the same terms and reference signs as those used in the first embodiment, and points of difference from the first embodiment are described.

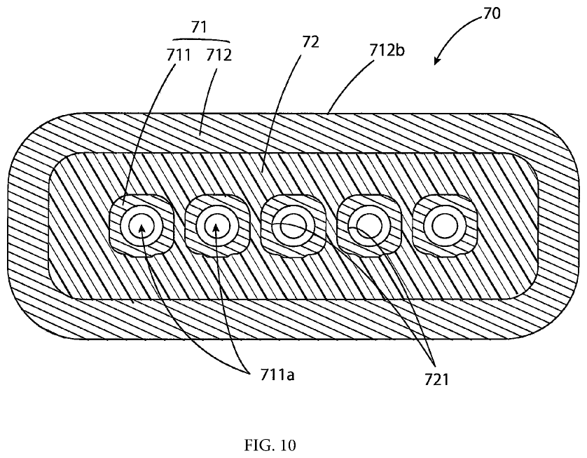

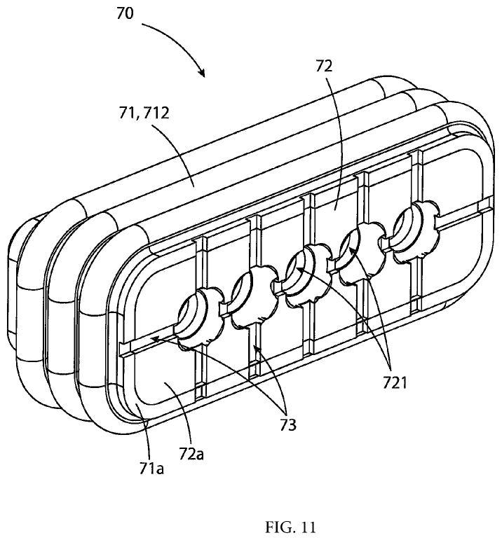

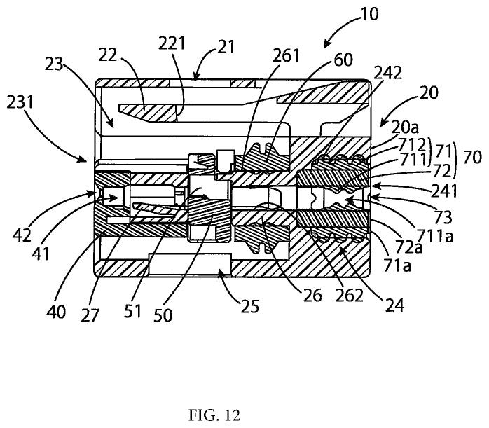

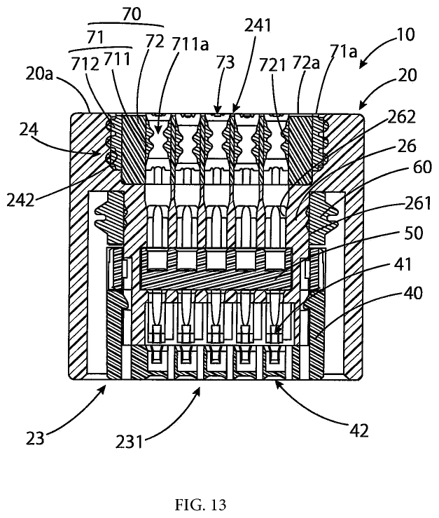

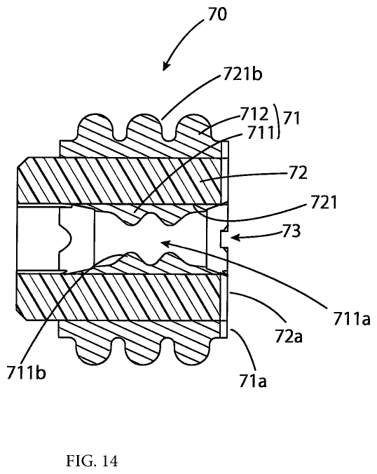

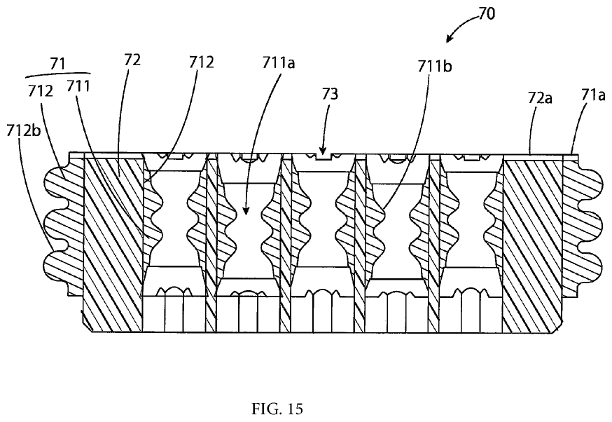

FIG. 11 is an isometric view of a waterproofing element that constitutes the waterproof connector of the second embodiment. The illustrated waterproofing element 70 is the second embodiment of the waterproofing element of the present invention. Further, FIGS. 12 and 13 are cross sectional views showing the waterproof connector of the second embodiment and corresponding to FIGS. 4 and 5 of the first embodiment, respectively. FIGS. 14 and 15 are cross sectional views showing the waterproofing element that constitutes the waterproof connector of the second embodiment and corresponding to FIGS. 8 and 9 of the first embodiment, respectively. As the cross sectional views of FIGS. 6 and 10 in the first embodiment appear as identical drawings in the second embodiment too, overlapped illustration is omitted here.

The waterproofing element 70 according to the second embodiment is constituted by a seal element 71 and a supporting element 72 having their respective back surfaces 71a and 72a flush or co-planar with each other. Further, in the case of the second embodiment, the back surfaces 71a and 72a, which are flush with each other, are also flush with the back surface 72a of the plug housing 20 as shown in FIGS. 12 and 13. Moreover, the drain groove 73 extends astride the back surface 71a of the seal element 71 and the back surface of the supporting element 72.

In the case of the waterproof connector 70 of the first embodiment described earlier, the supporting element 72 of the waterproofing element 70 protrudes from the back surface 20a of the plug housing 20, and the connector is large in size accordingly. On the other hand, in the case of a waterproof connector 10 of the second embodiment, the back surfaces 71a and 72a of the seal element 71 and the supporting element 72, which constitute the waterproofing element 70, are flush with each other and also flush with the back surface 20a of the plug housing 20. This achieves a size smaller than that of the waterproof connector 10 of the first embodiment. Further, since the waterproofing element 70 does not protrude as in the case of the waterproof connector 10 of the first embodiment, the occurrence of an accident in which the waterproofing element 70 breaks or allows entry of water by casually bumping into something is reduced.

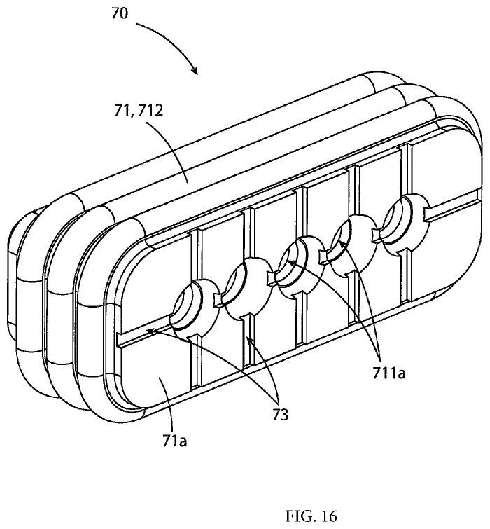

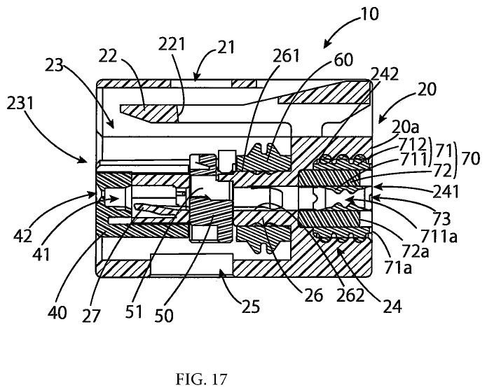

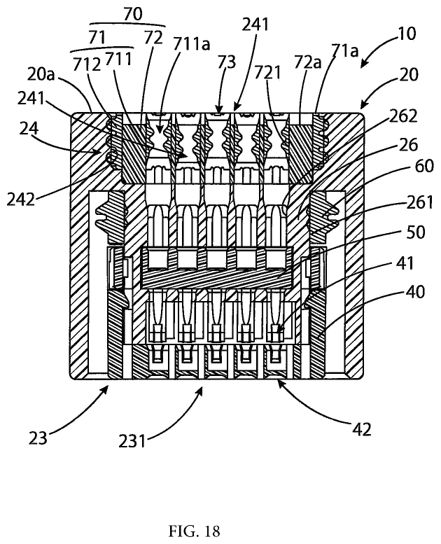

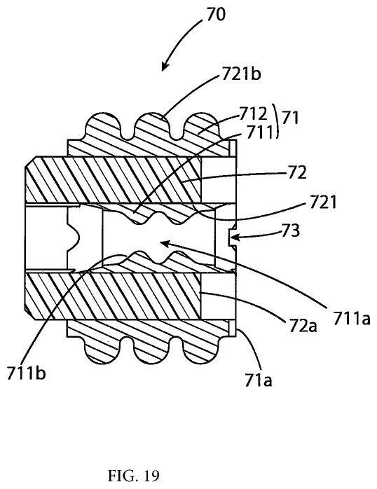

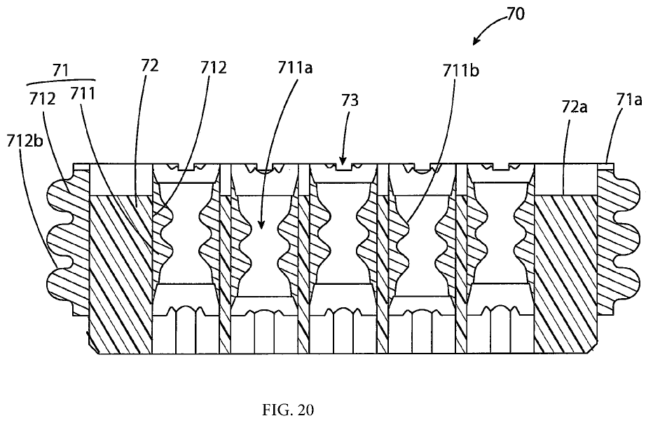

FIG. 16 is an isometric view of a waterproofing element 70 that constitutes a waterproof connector of a third embodiment. FIGS. 17 and 18 are cross sectional views showing the waterproof connector of the third embodiment and corresponding to FIGS. 4 and 5 of the first embodiment, respectively. FIGS. 19 and 20 are cross sectional views showing the waterproofing element that constitutes the waterproof connector of the third embodiment and corresponding to FIGS. 8 and 9 of the first embodiment, respectively. As the cross sectional views of FIGS. 6 and 10 in the first embodiment appear as identical drawings in the third embodiment too, overlapped illustration is omitted here.

The waterproofing element 70 according to the third embodiment is constituted by a seal element 71 having its back surfaces 71a flush with the back surface 20a of the plug housing 20 as shown in FIGS. 17 and 18. In distinction, the back surface 72a of the supporting element 72 is further forward than the back surface opening 241 of the plug housing 20 and is inside the plug housing 20. That is, the supporting element 72 is in an embedded shape embedded in the plug housing 20. For this reason, the drain groove 73 is formed in the back surface 71a of the seal element 71. Thus, depending on the use, waterproof reliability, or other features of the waterproof connector 10, the supporting element 72 may protrude from the back surface 20a of the plug housing 20 as in the case of the first embodiment, may be flush with the back surface 20a as in the case of the second embodiment, or may be in an embedded shape as in the case of the third embodiment.

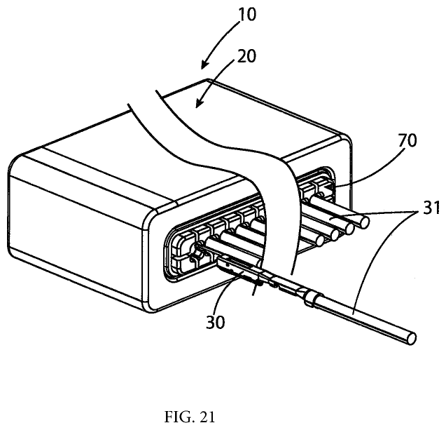

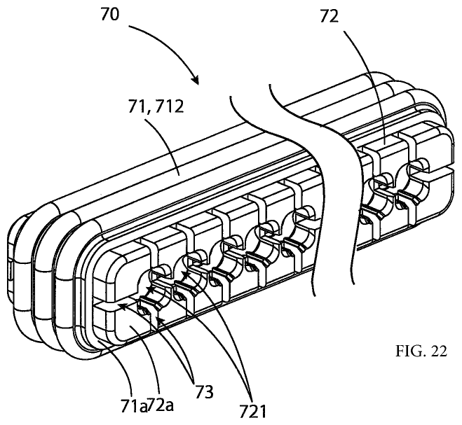

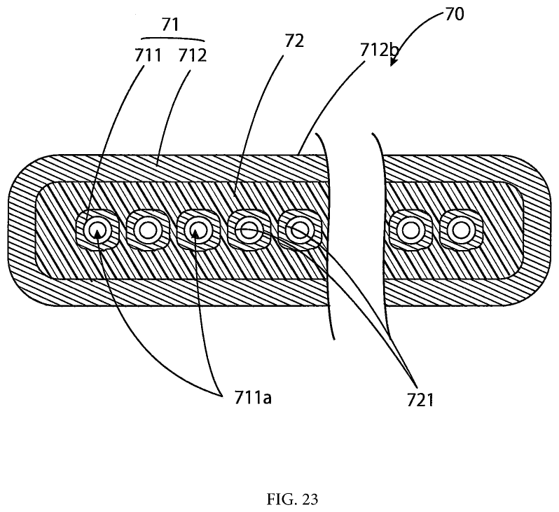

FIG. 21 is an isometric view of a waterproof connector of a fourth embodiment. Further, FIG. 22 is an isometric view of a waterproofing element that constitutes the waterproof connector of the fourth embodiment. FIG. 23 is a cross sectional view showing the waterproofing element that constitutes the waterproof connector of the fourth embodiment and corresponding to FIG. 10 in the first embodiment.

While each of the waterproofing elements 70 according to the first to third embodiments so far described is a type of waterproofing element that has a side-by-side arrangement of five first waterproofing portions 711 each having a plug hole 711a, a waterproof connector 10 of the fourth embodiment includes a waterproofing element 70 having a side-by-side array of a larger number of first waterproofing portions 711. As shown in the fourth embodiment, the number of first waterproofing portions 711 that are arranged side by side is not limited to 5 but may be a larger number such as 20. Alternatively, the number may be smaller than 5, for example 2 or 3.

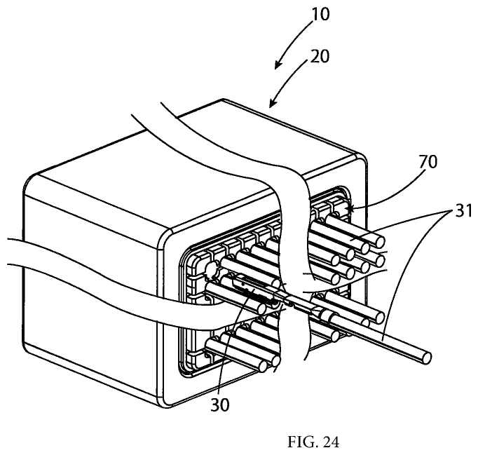

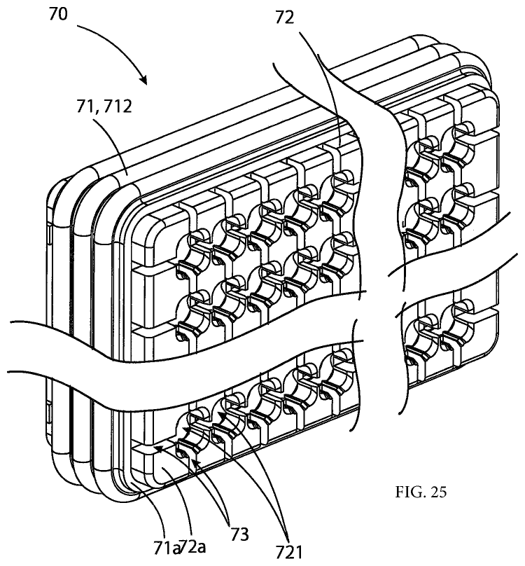

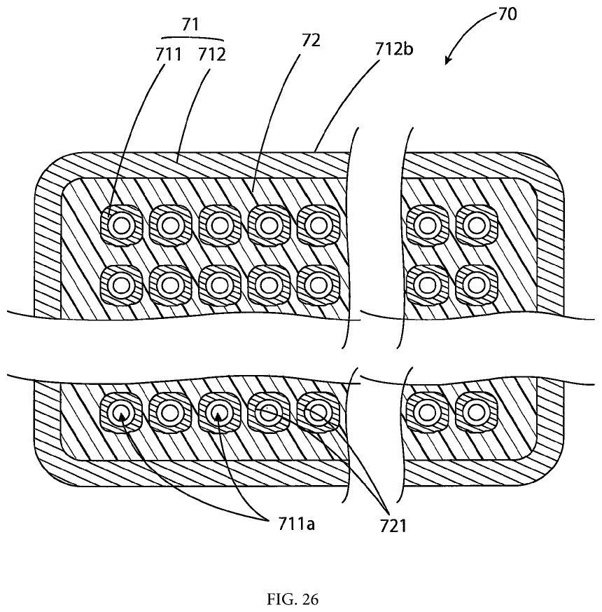

FIG. 24 is an isometric view of a waterproof connector of a fifth embodiment. FIG. 25 is an isometric view of a waterproofing element that constitutes the waterproof connector of the fifth embodiment. FIG. 26 is a cross sectional view showing the waterproofing element that constitutes the waterproof connector of the fifth embodiment and corresponding to FIG. 10 in the first embodiment.

While each of the waterproofing elements 70 according to the first to fourth embodiments so far described is a type of waterproofing element that has a side-by-side arrangement of first waterproofing portions 711 each having a plug hole 711a, a waterproof connector 10 of the fifth embodiment includes a waterproofing element also having a tandem array of a large number of first waterproofing portions.

As shown in the fifth embodiment, first waterproofing portions 711 are not always arranged or arrayed side by side, but a large number of rows of first waterproofing portions 711, e.g., ten rows of first waterproofing portions 711, may be arranged in tandem too. Alternatively, only a small number of rows of first waterproofing portions 711, e.g., two or three rows of first waterproofing portions may be arranged in tandem. Thus, what is called “waterproofing element” in the present invention has no upper limit on the number of first waterproofing portions 711. A larger number of first waterproofing portions 711, such as several hundreds of first waterproofing portions, may be arranged, provided the number is larger than or equal to 2. Furthermore, while the waterproofing element 70 according to the fifth embodiment has a large number of first waterproofing portions 711 simply arranged side by side and in tandem, what is called “waterproofing element” in the present invention does not need to have first waterproofing portions 711 arranged side by side or in tandem but may have first waterproofing portions 711 arrayed in another configuration such as a staggered arrangement.

Finally, while the foregoing description has taken the plug housing 20 and the female contacts as an example, what is called “housing” in the present invention may be a receptacle type housing, or what are called “contacts” in the present invention may be male contacts.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a plurality of contacts;
a housing having:
a mating portion adapted to be mated with a mating connector and defining a front opening; and
a waterproofed portion into which the plurality of contacts are plugged, the waterproofed portion including:
a rear opening; and
an inner wall surface defining the rear opening; and
a waterproofing element arranged within the waterproofed portion and adapted to prevent the entry of water into the connector, including:
a seal element having:
a plurality of first waterproofing portions each defining a plug hole into which one of the contacts is plugged and adapted to prevent water from entering an area surrounding the contact; and
a second waterproofing arranged in sealing contact with the inner wall surface of the waterproofed portion and adapted to prevent water to enter a space between the inner wall surface and the seal element, and
a supporting element surrounding the first waterproofing portions and adapted to prevent a misalignment of the first waterproofing portions, the supporting element pressing the second waterproofing portion against the inner wall surface and, in a state of being free from an external force, is in watertight contact with the seal element.

2. The connector according to claim 1, wherein the supporting element defines a plurality of through holes in which the respective ones of the plurality of first waterproofing portions are separately arranged.

3. The connector according to claim 1, wherein the seal element and the supporting element are integrally molded.

4. The connector according to claim 3, wherein the seal element and the supporting element are formed from distinct materials.

5. The connector according to claim 1, wherein the waterproofing element defines a drain groove formed into a rear end face thereof.

6. The connector according to claim 5, wherein the drain groove extends in a direction normal to a front-rear direction of the connector.

7. The connector according to claim 6, wherein the supporting element protrudes from the rear opening, and the drain groove is formed in the supporting element and is not formed in the seal element.

8. The connector according to claim 7, wherein the seal element is arranged entirely within the rear opening.

9. The connector according to claim 6, wherein rear-facing surfaces of the seal element and the supporting element defining the rear end face of the waterproofing element are flush with one another.

10. The connector according to claim 9, wherein the drain groove is formed through both the seal element and the supporting element.

11. The connector according to claim 6, wherein a rear end of the supporting element is oriented further forward in a direction toward a front of the connector than a rear end of the seal element and the rear opening.

12. The connector according to claim 11, and the drain groove is formed in the seal element and is not formed in the supporting element.

13. A waterproofing element, comprising:
a seal element, having:
a plurality of first waterproofing portions each defining a plug hole adapted to receive and form a seal with a conductive contact; and
a second waterproofing portion adapted to sealingly contact an inner wall surface of a housing; and
a supporting element surrounding the first waterproofing portions and adapted to prevent misalignment of the first waterproofing portions, the supporting element is arranged within and pressing the second waterproofing portion in a radially outward direction for sealingly engaging therewith.

14. The waterproofing element according to claim 13, wherein the supporting element defines a plurality of through holes in which the respective ones of the plurality of first waterproofing portions are separately arranged.

15. The waterproofing element according to claim 13, wherein the first waterproofing portions are discrete from the second waterproofing portion.

16. The waterproofing element according to claim 13, wherein:
the seal element is formed from a first material;
the supporting element is formed from a second material, distinct from the first material; and
the seal element and the supporting element are integrally molded.

17. The waterproofing element according to claim 13, wherein the waterproofing element defines a drain groove formed into a rear end face thereof, the drain groove extending in a direction normal to an axial direction of each of the plurality of through holes of the supporting element.

18. The waterproofing element according to claim 17, wherein rear end faces of the supporting element and the seal element are arranged generally flush with one another in the axial direction, and the drain groove is formed in the supporting element and the seal element.

19. The waterproofing element according to claim 17, wherein rear end faces of the supporting element and the seal element are arranged offset from one another in the axial direction, and the drain groove is formed only in the rear end face of the supporting element or the rear end face of the seal element, that is arranged closest to a rear side of the waterproofing element.

20. A connector comprising:
a housing, including:
a mating portion adapted to be mated with a mating connector and defining a first opening; and
a waterproofed portion adapted to receive a plurality of contacts, having:
a second opening; and
an inner wall surface defining the second opening; and
a waterproofing element arranged at least partially within second opening, including:
a supporting element defining a plurality of through holes; and
a seal, having:
a plurality of discrete first waterproofing portions arranged in a respective one of the plurality of through holes of the supporting element, each first waterproofing portion defining a plug hole adapted to receive one of the plurality of contacts; and
a second waterproofing arranged about an outer circumference of the supporting element and in sealing contact with the inner wall surface of the waterproofed portion.
